(19) United States
(12) Patent Application Publication
(10) Pub. No.: US 2021/0055880 A1
(43) Pub. Date: Feb. 25, 2021

(54) MEMORY CONTROLLER AND MEMORY MODULE

(71) Applicant: Sony Semiconductor Solutions Corporationn, Kanagawa (JP)

(72) Inventors: Ken Ishii, Tokyo (JP); Kenichi Nakanish, Tokyo (JP); Hideaki Okubo, Saitama (JP); Teruya Kaneda, Kanagawa (JP)

(21) Appl. No.: 16/959,511

(22) PCT Filed: Oct. 15, 2018
(86) PCT No.: PCT/JP2018/038309

§ 371 Date: Jul. 1, 2020

(30) Foreign Application Priority Data
Jan. 12, 2018 (JP) 2018-003256

(51) Int. Cl. G06F 3/06

(52) U.S. Cl. CPC G06F 3/0655; G06F 3/0679; G06F 3/0604

(57) ABSTRACT

Even data mapped to discrete physical addresses of a volatile memory is saved in a non-volatile memory.

A memory management information registration unit registers, as an entry of memory management information, a physical address of a first memory that is volatile memory and an address of a second memory that is a non-volatile memory, in association for every management unit. A control unit saves data from the first memory into the second memory in accordance with the memory management information in response to a save request, and restores data from the second memory into the first memory in accordance with the memory management information in response to a restore request.

### TECHNICAL FIELD

The present technology relates to a memory controller. Specifically, the present technology relates to a memory controller and a memory module for saving contents of a volatile memory into a non-volatile memory, and restoring.

### BACKGROUND ART

In a conventional memory device, a technique of saving data into a non-volatile memory and then restoring is used to prevent contents of a volatile memory from being lost. For example, there has been proposed a memory device that saves data of a DRAM, which is a volatile memory, into an NVRAM, which is a non-volatile memory, in response to an event of power interruption (for example, see Patent Document 1).

### CITATION LIST

### Patent Document

Patent Document 1: Japanese Patent Application Laid-Open No. 2017-045379

### SUMMARY OF THE INVENTION

### Problems to be Solved by the Invention

In the related art described above, addresses of the volatile memory and the non-volatile memory are managed for each program, and data of the volatile memory is saved in the non-volatile memory in accordance with the addresses. This related art assumes that each program is stored in continuous areas of the volatile memory, and manages one address for each program. However, data of an application operating on an operating system is often mapped to discrete physical addresses, and there is a problem that such data cannot be saved properly.

The present technology has been made in view of such a situation, and an object is to appropriately save even data mapped to discrete physical addresses of a volatile memory into a non-volatile memory.

### Solutions to Problems

The present technology has been made to solve the problem described above, and a first aspect thereof is a memory controller and a memory module that include: a memory management information registration unit that registers, as an entry of memory management information, a physical address of a first memory that is a volatile memory and an address of a second memory that is a non-volatile memory, in association for every management unit; and a control unit that saves data from the above-described first memory into the above-described second memory in accordance with the above-described memory management information in response to a save request, and restores data from the above-described second memory into the above-described first memory in accordance with the above-described memory management information in response to a restore request. Therefore, an action is exerted that data distributed and stored in the physical addresses of the first memory are saved into the second memory for every management unit, and restored.

Furthermore, in this first aspect, the above-described memory management information registration unit may register, as the above-described memory management information, a physical address of the above-described first memory and an address of the above-described second memory in association for every application. Therefore, an action is exerted that saving and restoration are performed for every application.

Furthermore, in this first aspect, the above-described control unit may save data from a physical address of the above-described first memory to an address of the above-described second memory in accordance with an entry of the above-described memory management information corresponding to an application specified in the above-described save request, and restore data from an address of the above-described second memory to a physical address of the above-described first memory in accordance with an entry of the above-described memory management information corresponding to an application specified in the above-described restore request. Therefore, an action is exerted that saving and restoration are performed with use of a physical address for every management unit of each application.

Furthermore, in this first aspect, the above-described memory management information registration unit may register, as the above-described memory management information, a physical address of the above-described first memory, an address of the above-described second memory, and an attribute related to a save operation in association for every application. Further, the above-described control unit may save data from a physical address of the above-described first memory to an address of the above-described second memory in accordance with an attribute of an entry of the above-described memory management information corresponding to an application specified in the above-described save request. Therefore, an action is exerted that necessity of saving is instructed in accordance with an attribute for every management unit.

Furthermore, in this first aspect, the above-described control unit may be connected to a memory access interface between with a host computer, and may access the above-described first or second memory in response to a request from the above-described host computer. Therefore, an action is exerted that a request from the host computer is accepted without awareness of distinction between the first memory and the second memory.

Furthermore, in this first aspect, there may also be provided a management size setting unit that sets, as a management size, a size of the above-described management unit corresponding to each entry in the above-described memory management information. Further, the above-described control unit may perform a process corresponding to the above-described save request or the above-described restore request in accordance with the above-described management size. Therefore, an action is exerted that the management size is set.

Furthermore, in this first aspect, the above-described control unit may generate a new entry in a case where there is no entry of the above-described memory management information corresponding to an application specified in a registration request of the above-described memory management information, and may register, in a case where there is a corresponding entry, a physical address specified in the registration request into the entry. Therefore, an action is exerted that the memory management information is registered.

Furthermore, in this first aspect, the above-described memory management information registration unit may register, as the above-described memory management information, a physical address and a virtual address of the above-described first memory and an address of the above-described second memory in association for every application. Therefore, an action is exerted that any management unit of each application is saved.

Furthermore, in this first aspect, the above-described control unit may generate a new entry in a case where there is no entry of the above-described memory management information corresponding to an application and a virtual address that are specified in a registration request of the above-described memory management information, and may register, in a case where there is a corresponding entry, a physical address specified in the registration request into the entry. Therefore, an action is exerted that the memory management information including a virtual address is registered.

### Effects of the Invention

According to the present technology, an excellent effect may be obtained in which even data mapped to discrete physical addresses of a volatile memory can be saved in a non-volatile memory. Note that the effects described herein are not necessarily limited, and any of the effects described in the present disclosure is possible.

### BRIEF DESCRIPTION OF DRAWINGS

FIG. 1 is a diagram illustrating an example of an overall configuration of an information processing system according to a first embodiment of the present technology.

FIG. 2 is a diagram illustrating a configuration example of a memory controller 240 according to the first embodiment of the present technology.

FIG. 3 is a view illustrating an example of management size information and memory management information according to the first embodiment of the present technology.

FIG. 4 is a view illustrating an example of a save operation according to the first embodiment of the present technology.

FIG. 5 is a view illustrating an example of a restore operation according to the first embodiment of the present technology.

FIG. 6 is a view illustrating an example of a request issued to the memory controller 240 according to the first embodiment of the present technology.

FIG. 7 is a flowchart illustrating an example of a processing procedure of the memory controller 240 according to an embodiment of the present technology.

FIG. 8 is a flowchart illustrating an example of a processing procedure of a management size setting process according to the first embodiment of the present technology.

FIG. 9 is a flowchart illustrating an example of a processing procedure of a memory management information registration process according to the first embodiment of the present technology.

FIG. 10 is a flowchart illustrating an example of a processing procedure of a save operation according to the first embodiment of the present technology.

FIG. 11 is a flowchart illustrating an example of a processing procedure of a restore operation according to the first embodiment of the present technology.

FIG. 12 is a view illustrating an example of management size information and memory management information according to a second embodiment of the present technology.

FIG. 13 is a view illustrating an example of a save operation according to the second embodiment of the present technology.

FIG. 14 is a view illustrating an example of a restore operation according to the second embodiment of the present technology.

FIG. 15 is a view illustrating an example of a request issued to a memory controller 240 according to the second embodiment of the present technology.

FIG. 16 is a flowchart illustrating an example of a processing procedure of a memory management information registration process according to the second embodiment of the present technology.

FIG. 17 is a view illustrating an example of management size information and memory management information according to a third embodiment of the present technology.

FIG. 18 is a view illustrating an example of a request issued to a memory controller 240 according to the third embodiment of the present technology.

FIG. 19 is a flowchart illustrating an example of a processing procedure of a save operation according to the third embodiment of the present technology.

FIG. 20 is a diagram illustrating an example of an overall configuration of an information processing system according to a fourth embodiment of the present technology.

FIG. 21 is a diagram illustrating a configuration example of a memory controller 240 according to the fourth embodiment of the present technology.

### MODE FOR CARRYING OUT THE INVENTION

Hereinafter, embodiments for implementing the present technology (hereinafter, referred to as embodiments) will be described. The description will be made in the following order.

1. First embodiment (example of managing for every management unit in accordance with memory management information)

2. Second embodiment (example of storing virtual address of volatile memory into memory management information)

3. Third embodiment (example of storing attribute information into memory management information)

4. Fourth embodiment (example of virtualizing address space of memory module)

### 1. First Embodiment

[System Configuration]

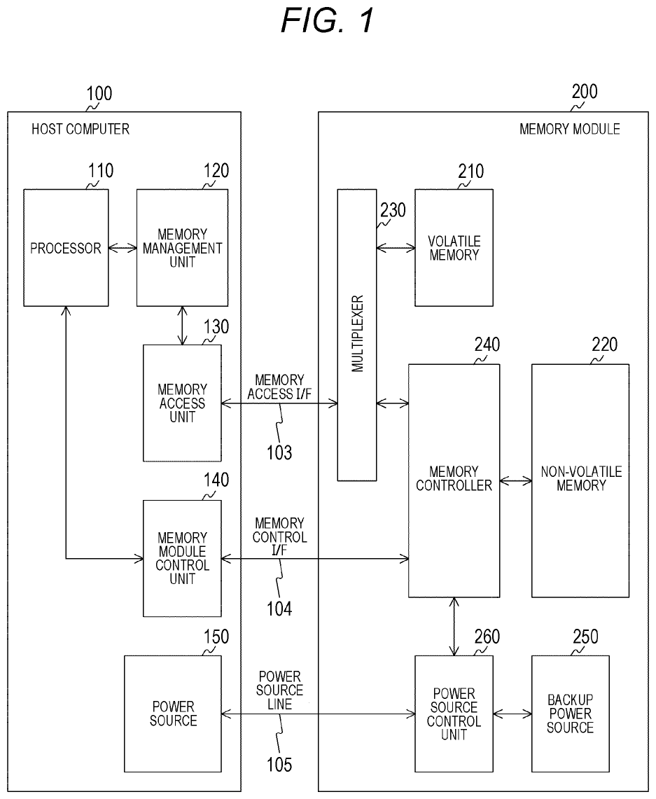

FIG. 1 is a diagram illustrating an example of an overall configuration of an information processing system according to a first embodiment of the present technology. This system includes a host computer 100 and a memory module 200.

The host computer 100 is to process data read from the memory module 200 and write processing result data into the memory module 200. This host computer 100 includes a processor 110, a memory management unit 120, a memory access unit 130, a memory module control unit 140, and a power source 150.

The processor 110 is a processing device that performs processing as the host computer 100. An operating system and applications running thereon are executed by this processor 110.

The memory management unit 120 is a memory management unit (MMU) that manages a memory space in the memory module 200. This memory management unit 120 performs conversion processing between a logical address and a physical address as a part of processing.

The memory access unit 130 is to control access to the memory module 200. This memory access unit 130 is connected to the memory module 200 via a memory access interface 103, and performs data write and read access to the memory module 200.

The memory module control unit 140 is to perform control for using the memory module 200. This memory module control unit 140 is connected to the memory module 200 via a memory control interface 104 and issues a request to the memory module 200. As the memory control interface 104, for example, a serial bus such as I²C is assumed.

The power source 150 is a power source for the host computer 100. This power source 150 is also connected to the memory module 200 via a power source line 105, and supplies power to the memory module 200. A voltage level of this power source 150 is monitored by the operating system. When an event such as instantaneous power failure (instantaneous interruption) is detected, the memory module control unit 140 issues a save request to the memory module 200 via the memory control interface 104. Therefore, the save process from a volatile memory 210 to a non-volatile memory 220 is performed in the memory module 200.

The memory module 200 is a memory device that reads and writes data in accordance with a request from the host computer 100. This memory module 200 includes the volatile memory 210, the non-volatile memory 220, a multiplexer 230, a memory controller 240, a backup power source 250, and a power source control unit 260.

The volatile memory 210 is a memory that requires power supply to maintain storage. For example, a dynamic random access memory (DRAM) or the like is assumed. Note that the volatile memory 210 is an example of a first memory described in the claims.

The non-volatile memory 220 is a memory that does not require power supply to maintain storage. For example, a resistance RAM (ReRAM), a phase-change RAM (PCRAM), a magnetoresistive RAM (MRAM), a NAND flash, and the like are assumed. Note that the non-volatile memory 220 is an example of a second memory described in the claims.

The multiplexer 230 is to switch a connection destination of the volatile memory 210 to either the memory controller 240 or the host computer 100. When the host computer 100 accesses the volatile memory 210, the multiplexer 230 switches the connection destination of the volatile memory 210 to the host computer 100 (the memory access interface 103). At a time of saving into the non-volatile memory 220 or restoring, the multiplexer 230 switches the connection destination of the volatile memory 210 to the memory controller 240.

The memory controller 240 is to control access to the volatile memory 210 and the non-volatile memory 220. This memory controller 240 decodes a request received from the host computer 100 via the memory control interface 104, and performs processing according to the request.

The backup power source 250 is a power source used in a case where the power supply from the power source 150 via the power source line 105 is interrupted due to instantaneous power failure or the like. This backup power source 250 is a large-capacity capacitor (supercapacitor), and has a function of supplying power to the memory module 200 for a time period (for example, about one minute to several tens of seconds) necessary for saving from the volatile memory 210 into the non-volatile memory 220.

The power source control unit 260 is to control a power source of the memory module 200. This power source control unit 260 switches so as to entirely supply power received from the power source 150 via the power source line 105 during a normal operation, and entirely supply power from the backup power source 250 at a time of instantaneous power failure or the like.

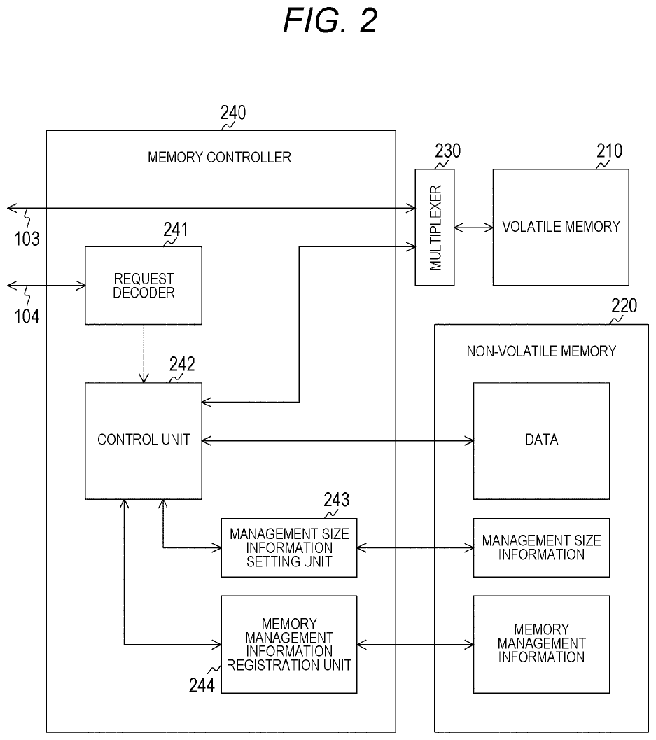

FIG. 2 is a diagram illustrating a configuration example of the memory controller 240 according to the first embodiment of the present technology.

The memory controller 240 includes a request decoder 241, a control unit 242, a management size information setting unit 243, and a memory management information registration unit 244.

The request decoder 241 is a decoder that decodes a request received from the host computer 100 via the memory control interface 104. This request decoder 241 discriminates a request and supplies a discrimination result to the control unit 242.

The control unit 242 is to perform processing related to the volatile memory 210 and the non-volatile memory 220 in accordance with the discrimination result of the request by the request decoder 241. This control unit 242 performs, for example, saving from the volatile memory 210 into a data area of the non-volatile memory 220 and restoration. Details of the processing will be described later.

The management size information setting unit 243 is to set, as a management size, a size of a management unit at a time of saving from the volatile memory 210 into the non-volatile memory 220 and restoring. The set management size is stored in the non-volatile memory 220.

The memory management information registration unit 244 is to register memory management information for management of a corresponding relationship between the volatile memory 210 and the non-volatile memory 220 at a time of saving from the volatile memory 210 into the non-volatile memory 220 and restoring. The registered memory management information is stored in the non-volatile memory 220.

[Management Size Information and Memory Management Information]

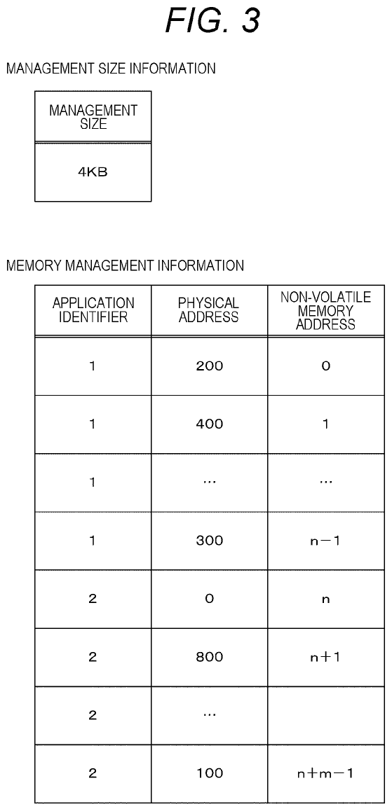

FIG. 3 is a view illustrating an example of management size information and memory management information according to the first embodiment of the present technology.

The management size information includes a management size that is a size of a management unit at a time of saving from the volatile memory 210 into the non-volatile memory 220 and restoring. In this example, 4 KB is assumed as the management unit. This management size can be set in accordance with a management unit of the operating system. Therefore, for example, in a case where a large page of 2 MB or the like is used in the operating system, this management size can be set to such a size.

The memory management information includes an entry for every management unit, and each entry stores an application identifier, a physical address of the volatile memory 210, and an address of the non-volatile memory 220 in association with each other.

The application identifier is an identifier for identifying an application program executed by the processor 110. In this example, two application identifiers “1” and “2” are shown.

The physical address of the volatile memory 210 may be assigned from 0, in units of the management size set as the management size information, or may be indicated in units of bytes.

[Save and Restore]

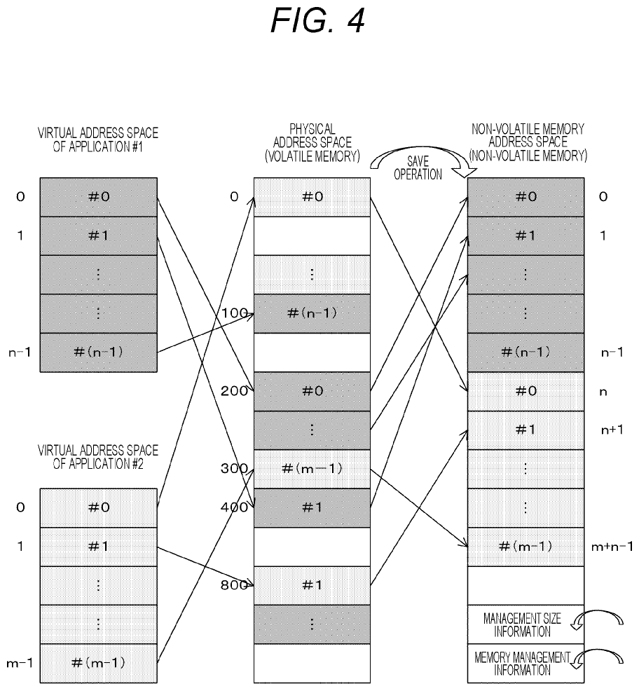

FIG. 4 is a view illustrating an example of a save operation according to the first embodiment of the present technology.

When a plurality of applications is operating, each operates in a virtual address space. The memory management unit 120 of the host computer 100 sections the virtual address space with a certain size, and converts into physical addresses in the sectioned units. In the present embodiment, 4 KB is assumed as described above. The physical address is assigned by the memory management unit 120 of the host computer 100, but is not always assigned to the same physical address every time. Therefore, it is necessary to be able to recover (restore) data even when different physical addresses are assigned between the save at source-off and the next power-on.

In this example, a virtual address space of application #1 whose application identifier is “1” is formed by n pages, and a virtual address space of application #2 whose application identifier is “2” is formed by m pages. These pages are discretely arranged in a physical address space of the volatile memory 210.

In the save operation, data of the management unit discretely arranged in the physical address space of the volatile memory 210 are stored in continuous areas of the non-volatile memory 220, in accordance with the memory management information. Therefore, there is an advantage that storing of an unused area of the non-volatile memory 220 is no longer necessary, a save time can be shortened, and a used capacity of the non-volatile memory 220 can be reduced.

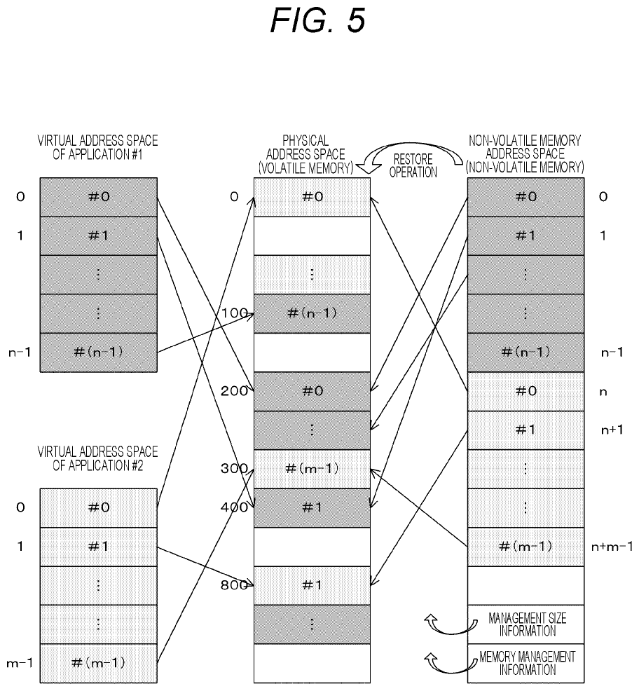

FIG. 5 is a view illustrating an example of a restore operation according to the first embodiment of the present technology.

In the restore operation, data of the management unit stored in continuous areas of the non-volatile memory 220 are restored to the physical address space of the volatile memory 210 in accordance with the memory management information.

At this time, when the memory management information is rewritten before the restore, the restore can be made to a different physical area of the volatile memory 210. That is, at a time of activation after power-cut, the operating system may assign a different physical address than that at a time of saving. However, according to the present embodiment, it is possible to restore into an appropriate physical area even in that case.

[Type of Request]

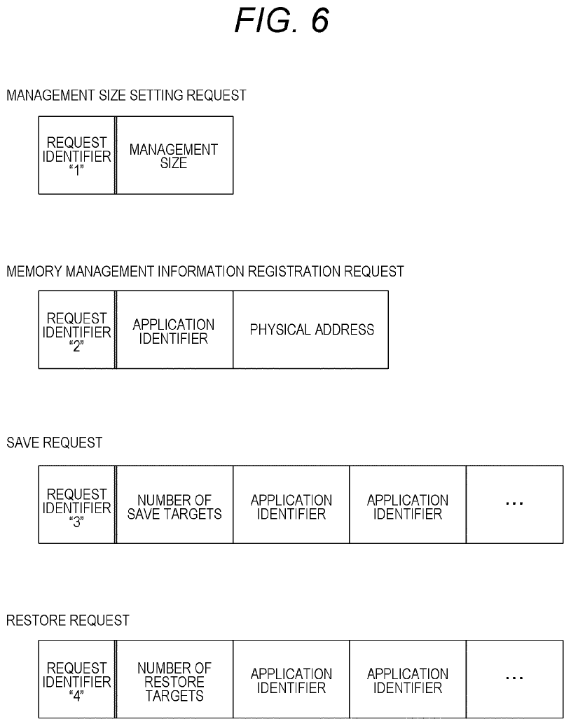

FIG. 6 is a view illustrating an example of a request issued to the memory controller 240 according to the first embodiment of the present technology.

Here, four requests issued to the memory controller 240 via the memory control interface 104 will be described as an example. A request issued through the memory control interface 104 indicates a request identifier, and a type of the request can be discriminated by decoding the request identifier with the request decoder 241.

In a case where the request identifier indicates “1”, the request is discriminated to be a management size setting request. This management size setting request passes “management size” as an argument. Therefore, the control unit 242 sets the management size.

In a case where the request identifier indicates “2”, the request is discriminated to be a memory management information registration request. This memory management information registration request passes “application identifier” and “physical address” as arguments. Therefore, the control unit 242 registers memory management information.

In a case where the request identifier indicates “3”, the request is discriminated to be a save request. This save request passes “number of save targets” and “application identifier” corresponding to the number, as arguments. Therefore, the control unit 242 saves data corresponding to the application identifier from the volatile memory 210 into the non-volatile memory 220. Note that, instead of specifying “application identifier”, an instruction may be made with all application identifiers as targets.

In a case where the request identifier indicates “4”, the request is discriminated to be a restore request. This restore request passes “number of restore targets” and “application identifier” corresponding to the number, as arguments. Therefore, the control unit 242 restores data corresponding to an application identifier from the non-volatile memory 220 into the volatile memory 210. Note that, instead of specifying “application identifier”, an instruction may be made with all application identifiers as targets.

[Operation]

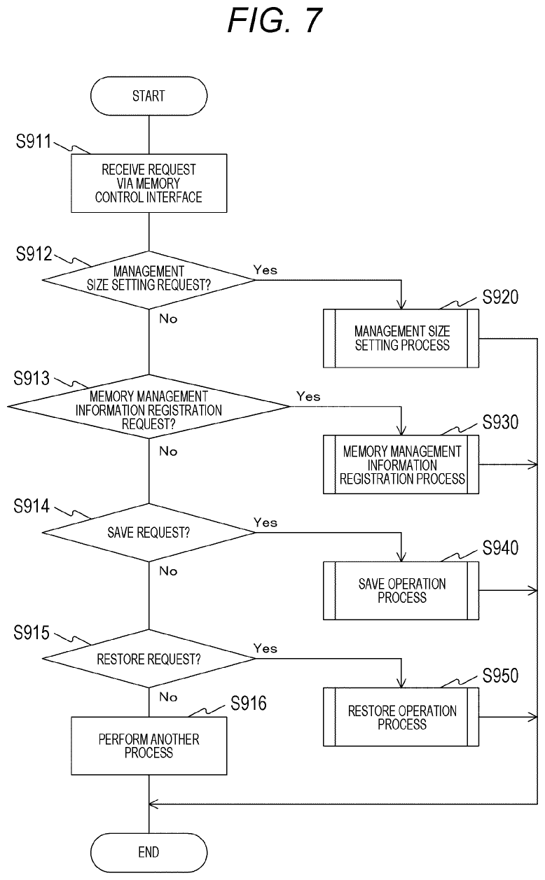

FIG. 7 is a flowchart illustrating an example of a processing procedure of the memory controller 240 according to an embodiment of the present technology.

When receiving a request via the memory control interface 104 (step S911), the memory controller 240 performs decoding by the request decoder 241 and performs processing according to a type of the request (steps S912 to S915). That is, when the type of the request is the management size setting request (step S912: Yes), a management size setting process is performed (step S920). When the type of the request is the memory management information registration request (step S913: Yes), a memory management information registration process is performed (step S930). When the type of the request is the save request (step S914: Yes), a save operation process is performed (step S940). When the type of the request is the restore request (step S915: Yes), a restore operation process is performed (step S950).

Note that, in a case where the type of request is other than the four shown here (step S915: No), another process is performed (step S916). As another request, for example, a request for deleting an entry of the memory management information, and the like are assumed.

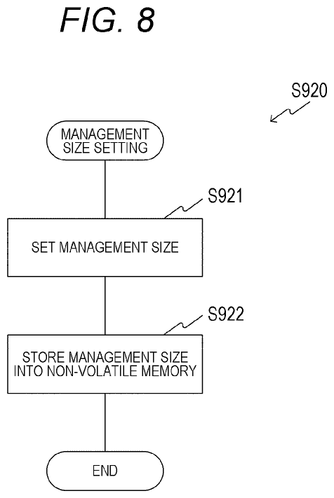

FIG. 8 is a flowchart illustrating an example of a processing procedure of the management size setting process according to the first embodiment of the present technology.

The management size information setting unit 243 sets “management size” passed as an argument of the management size setting request, as a size of the management unit (step S921). Then, the management size is stored in the management size information of the non-volatile memory 220 (step S922).

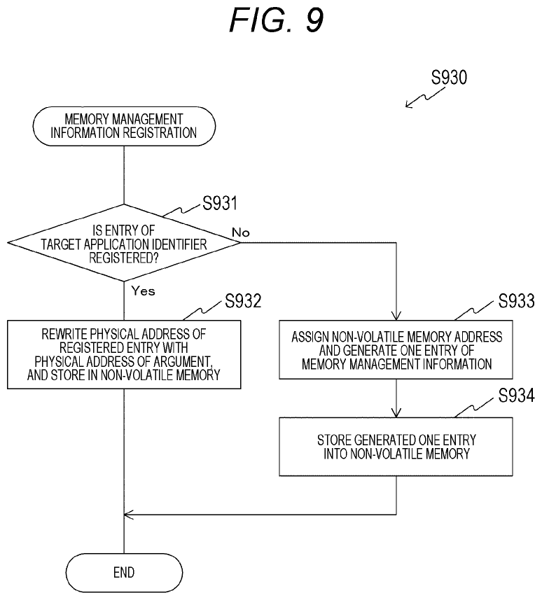

FIG. 9 is a flowchart illustrating an example of a processing procedure of the memory management information registration process according to the first embodiment of the present technology. Note that a plurality of entries may correspond to one application identifier, but it is assumed that a virtual address is not specified as an argument in this first embodiment. Therefore, in registration of the memory management information, the registration is to be made in each entry in ascending order of the virtual address, for example.

The memory management information registration unit 244 registers the memory management information in accordance with the following procedure. First, a search is made as to whether or not an entry of “application identifier” passed as an argument of the memory management information registration request is registered as the memory management information (step S931).

In a case where registration has already been made (step S931: Yes), a physical address of the registered entry is replaced with “physical address” passed as an argument of the memory management information registration request, and stored in the memory management information of the non-volatile memory 220 (step S932).

Whereas, in a case where the registration has not been made yet (step S931: No), an area is assigned in the non-volatile memory 220, and one entry of the memory management information is generated by combining a head address of the area and information of an argument of the memory management information registration request (step S933). Then, the generated one entry of the memory management information is stored in the memory management information of the non-volatile memory 220 (step S934).

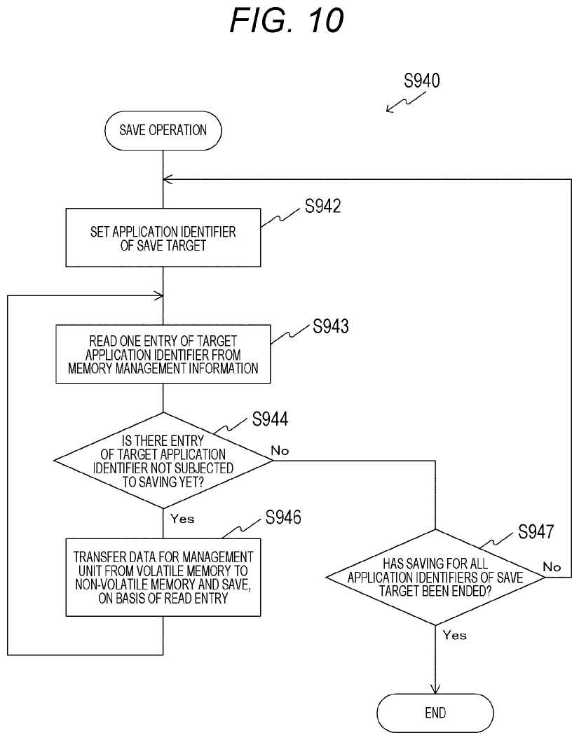

FIG. 10 is a flowchart illustrating an example of a processing procedure of the save operation according to the first embodiment of the present technology.

The control unit 242 performs the save operation process in accordance with the following procedure. First, “application identifier” passed as an argument of the save request is sequentially set as an application identifier to be processed (step S942). Then, an entry of the application identifier to be processed is searched for from the memory management information stored in the non-volatile memory 220 (step S943).

When there is data that has not been saved in the entry of the application identifier to be processed (step S944: Yes), the data for the management unit is transferred from the volatile memory 210 to the non-volatile memory 220 and saved on the basis of the read entry (step S946). That is, saving is performed from a physical address of the volatile memory 210 in the entry of the memory management information to an address of the non-volatile memory 220. Then, returning to step S943, another entry of the application identifier to be processed is searched for.

Whereas, when saving of all management units is completed in the application identifier to be processed (step S944: No), it is determined whether or not there is another save target among “application identifiers” passed as arguments of the save request (step S947). When there is an application identifier that has not been subjected to the saving yet (step S947: No), the process returns to step S942, and the application identifier is set as the processing target.

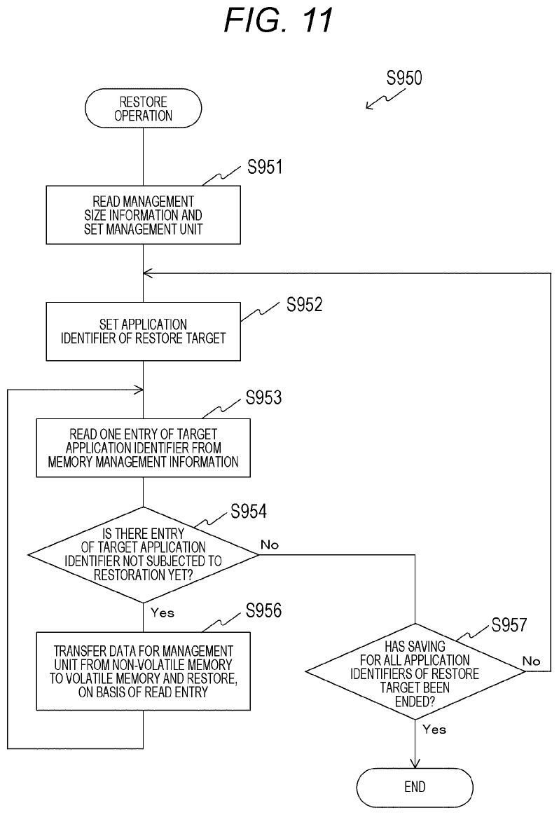

FIG. 11 is a flowchart illustrating an example of a processing procedure of a restore operation according to the first embodiment of the present technology.

The control unit 242 performs the restore operation process in accordance with the following procedure. First, management size information is read from the non-volatile memory 220, and a management unit is set (step S951). Furthermore, “application identifier” passed as an argument of the restore request is sequentially set as an application identifier to be processed (step S952). Then, an entry of the application identifier to be processed is searched for from the memory management information stored in the non-volatile memory 220 (step S953).

When there is data that has not been restored in the entry of the application identifier to be processed (step S954: Yes), the data for the management unit is transferred from the non-volatile memory 220 to the volatile memory 210 and restored on the basis of the read entry (step S956). That is, restore is performed from an address of the non-volatile memory 220 in the entry of the memory management information to a physical address of the volatile memory 210. Then, returning to step S953, another entry of the application identifier to be processed is searched for.

Whereas, when restore of all management units is completed in the application identifier to be processed (step S954: No), it is determined whether or not there is another restore target among “application identifiers” passed as arguments of the restore request (step S957). When there is an application identifier that has not been subjected to the restore yet (step S957: No), the process returns to step S952, and the application identifier is set as the processing target.

Thus, according to the first embodiment of the present technology, data mapped to discrete physical addresses of the volatile memory 210 can be saved in the non-volatile memory 220 and restored by managing for every management unit as the memory management information.

### 2. Second Embodiment

In the first embodiment described above, assuming that data to be saved and restored are continuous in a virtual address space, only a physical address of the volatile memory 210 has been stored in each entry of the memory management information. Whereas, in this second embodiment, by further storing a virtual address of a volatile memory 210, discontinuous areas on the virtual address are also targeted for saving and restoration. That is, it is possible to selectively save a necessary portion.

Note that a system configuration is similar to that of the first embodiment described above, and a detailed description thereof will be omitted.

[Management Size Information and Memory Management Information]

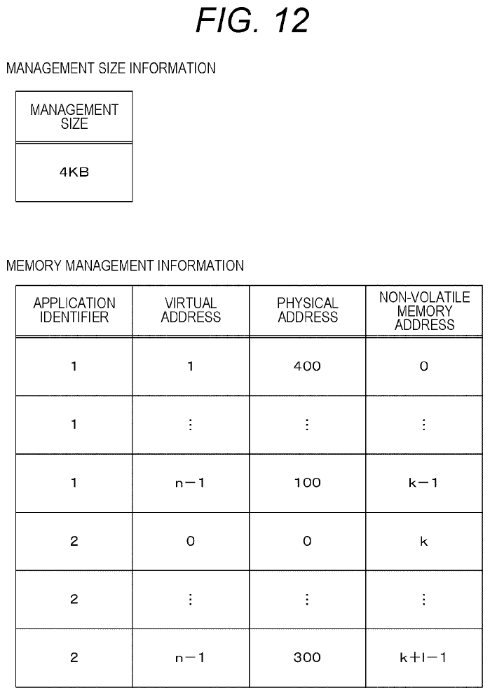

FIG. 12 is a view illustrating an example of management size information and memory management information according to the second embodiment of the present technology.

The management size information is similar to that in the first embodiment described above, and in this example, 4 KB is assumed as a management unit.

The memory management information further stores a virtual address of the volatile memory 210, in addition to the first embodiment described above. As this virtual address, a different address space can be assigned to each application. As described above, by managing a virtual address of the volatile memory 210 as the memory management information, it is possible to save only data of a necessary virtual address.

[Save and Restore]

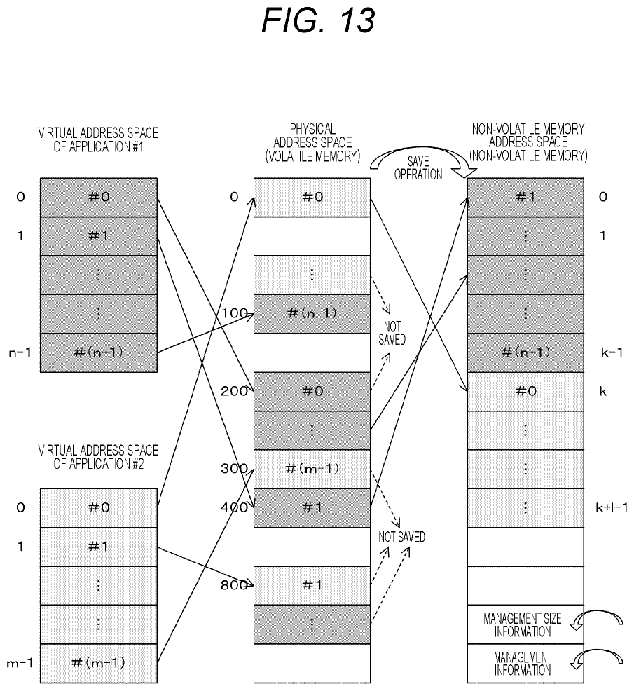

FIG. 13 is a view illustrating an example of a save operation according to the second embodiment of the present technology.

In the first embodiment described above, saving is performed on continuous areas in a virtual address space. However, in this second embodiment, by storing the virtual address of the volatile memory 210 in each entry of the memory management information, discrete areas to be a save target can be selectively instructed with the virtual address.

Also in this case, saved data is stored in continuous areas of the non-volatile memory 220. Therefore, in a case where k pieces of management unit of application #1 are registered in the memory management information, storage is made in continuous areas of the k pieces of management unit on the non-volatile memory 220.

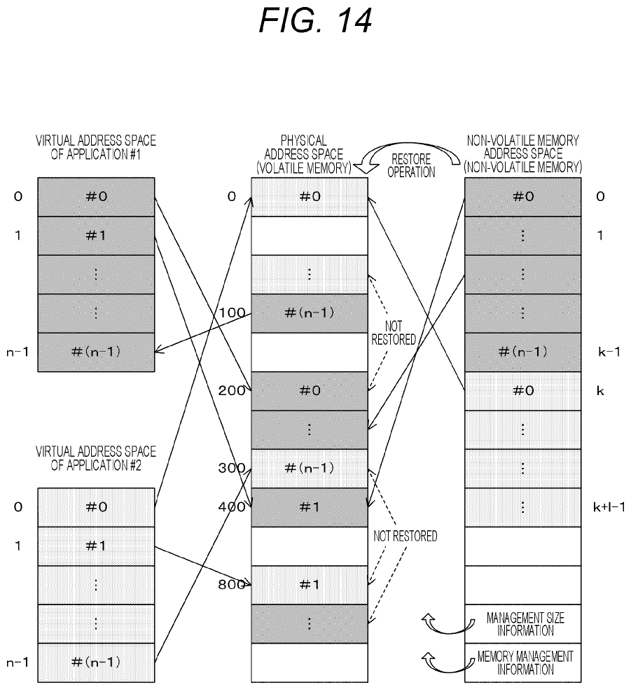

FIG. 14 is a view illustrating an example of a restore operation according to the second embodiment of the present technology.

In this second embodiment, as described above, in the save operation, discrete areas in a virtual address space are saved in continuous areas of the non-volatile memory 220. Therefore, in the restore operation, the management units stored in the continuous areas of the non-volatile memory 220 are individually restored to the virtual address space. That is, some management units may not be restored in the volatile memory 210.

[Type of Request]

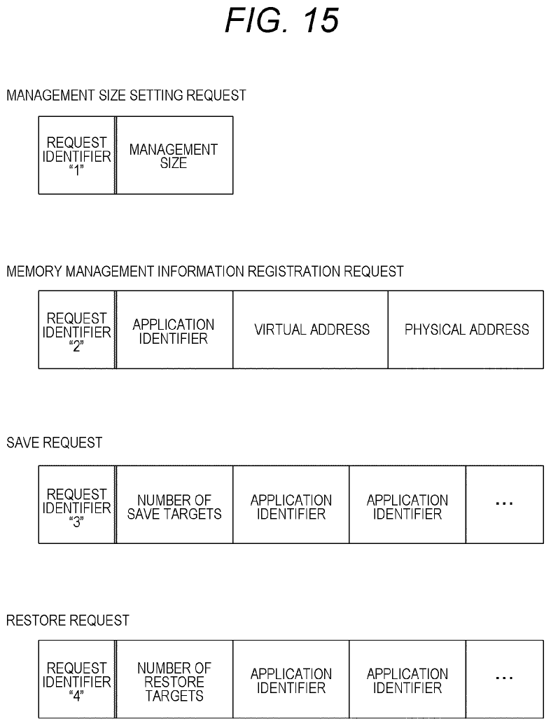

FIG. 15 is a view illustrating an example of a request issued to the memory controller 240 according to the second embodiment of the present technology.

In this second embodiment, a management size setting request, a save request, and a restore request are similar to those in the first embodiment described above. Then, a memory management information registration request is to pass “virtual address” of the volatile memory 210 as an argument, in addition to a case of the first embodiment described above. In this second embodiment, the virtual address is registered together in each entry on the basis of this argument, in registering memory management information.

[Operation]

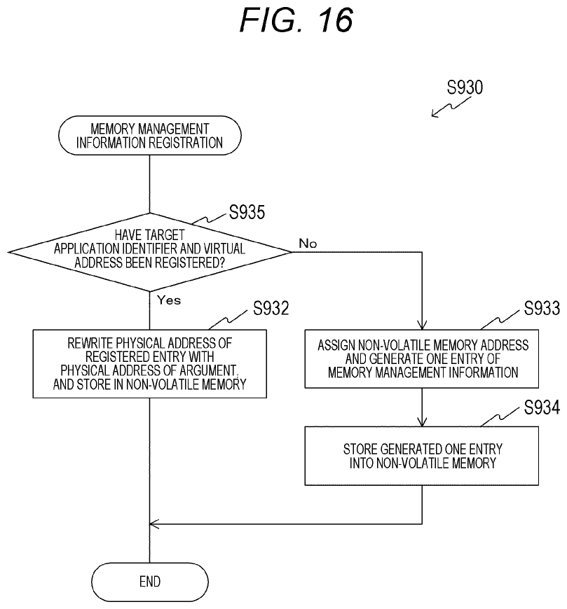

FIG. 16 is a flowchart illustrating an example of a processing procedure of a memory management information registration process according to the second embodiment of the present technology. Note that a processing procedure of other processing is similar to that of the first embodiment described above, and a detailed description thereof will be omitted.

In the first embodiment described above, a search has been made as to whether or not an entry of “application identifier” passed as an argument of the memory management information registration request is registered as the memory management information (step S931). Whereas, in this second embodiment, a search is made as to whether or not an entry having a combination of “application identifier” and “virtual address” passed as arguments of the memory management information registration request is registered as the memory management information (step S935). As a result, when a corresponding entry has already been registered, step S932 is executed, and when not registered yet, step S933 is executed. Subsequent processing contents are similar to those in the first embodiment described above.

As described above, according to the second embodiment of the present technology, by managing a virtual address of the volatile memory 210 as the memory management information, it is possible to save only data of a necessary virtual address.

3. Third Embodiment

In the first and second embodiments described above, data of all management units managed as the memory management information have been targeted for saving and restoration. Whereas, for example, a case in which different data is desired to be set as a save target depending on normal power-off and instantaneous power failure or other cases may occur. Thus, in this third embodiment, necessity of saving can be specified conditionally for every management unit.

Note that a system configuration is similar to that of the first embodiment described above, and a detailed description thereof will be omitted.

[Management Size Information and Memory Management Information]

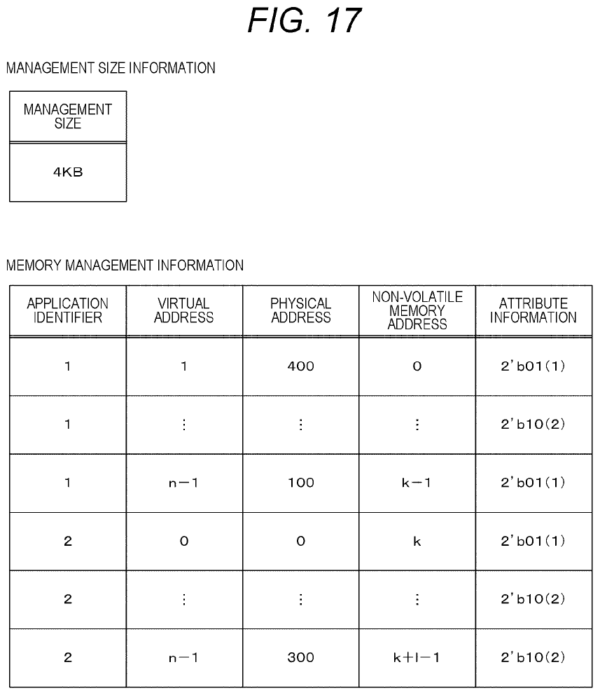

FIG. 17 is a view illustrating an example of management size information and memory management information according to the third embodiment of the present technology.

The management size information is similar to that in the first embodiment described above, and in this example, 4 KB is assumed as a management unit.

The memory management information further stores attribute information, in addition to the second embodiment described above. This attribute information is to specify a condition at a time of saving for every management unit, and a save operation is to be performed on condition of being coincide with “attribute condition” of an argument of a save request described later.

[Type of Request]

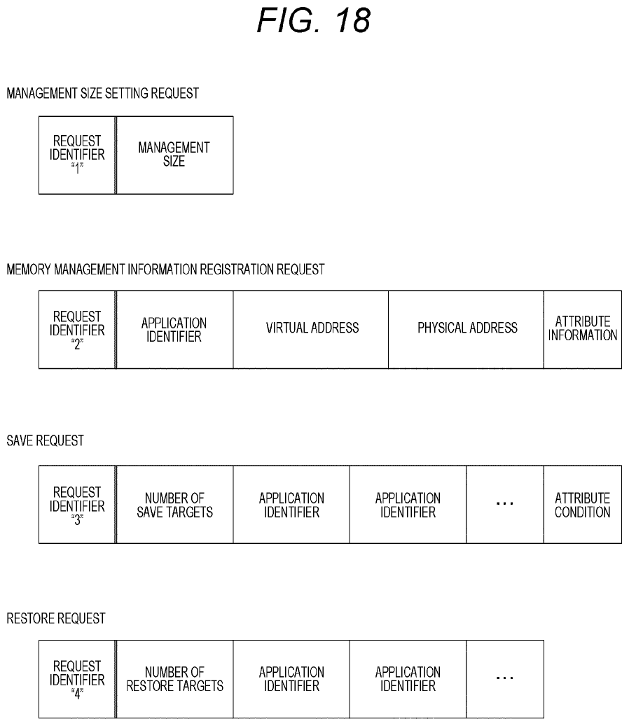

FIG. 18 is a view illustrating an example of a request issued to a memory controller 240 according to the third embodiment of the present technology.

In this third embodiment, a management size setting request and a restore request are similar to those in the first embodiment described above.

A memory management information registration request is to pass “virtual address” and “attribute information” of the volatile memory 210 as arguments, in addition to a case of the first embodiment described above. “Virtual address” is similar to that added in the second embodiment described above. Furthermore, “attribute information” specifies a condition at a time of saving for every management unit, and is registered as attribute information of the memory management information described above.

The save request is to pass “attribute condition” as an argument, in addition to a case of the first embodiment described above. This “attribute condition” specifies that the save operation is to be performed on condition that the attribute information is coincident with attribute information of each entry of the memory management information. For example, suppose that either “1” or “2” is set as the attribute information of the memory management information. At this time, in a case where “attribute condition” is “1”, only an entry whose attribute information of the memory management information indicates “1” is to be a save target. Furthermore, in a case where “attribute condition” is “2”, only an entry whose attribute information of the memory management information indicates “2” is to be a save target. Then, in a case where “attribute condition” is “3”, an entry whose attribute information of the memory management information indicates “1” and an entry whose attribute information of the memory management information indicates “2” are to be a save target.

[Operation]

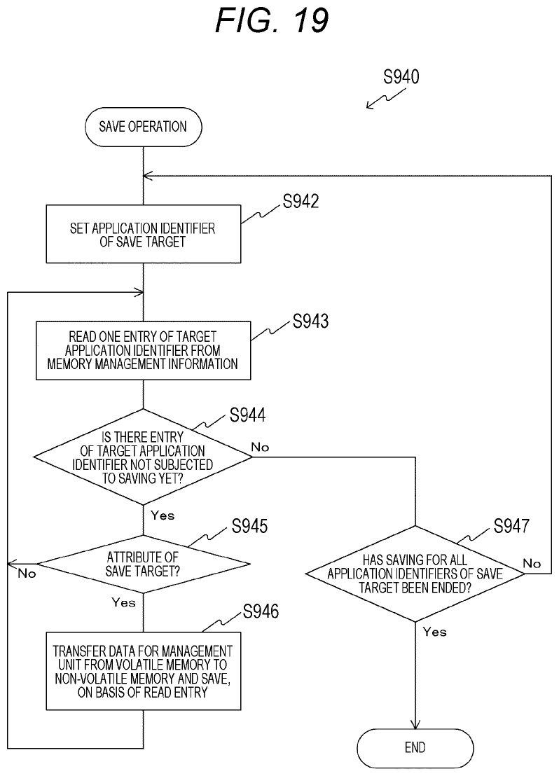

FIG. 19 is a flowchart illustrating an example of a processing procedure of the save operation according to the third embodiment of the present technology. Note that a processing procedure of other processing is similar to that of the first or second embodiment described above, and a detailed description thereof will be omitted.

The control unit 242 performs a save operation process in accordance with the following procedure. However, steps S942 to S944, S946, and S947 are similar to those in the first embodiment described above.

When there is data that has not been saved in the entry of the application identifier to be processed (step S944: Yes), before saving in step S946, it is determined whether or not the management unit has an attribute of a save target (step S945). That is, “attribute condition” passed as an argument of the save request is compared with “attribute information” in the entry of the memory management information, and, only in a case where the condition is satisfied (step S945: Yes), saving is performed (step S946). Then, returning to step S943, another entry of the application identifier to be processed is searched for.

Thus, according to the third embodiment of the present technology, by managing “attribute information” as the memory management information, only the management unit that is coincident with the argument “attribute condition” of the save request can be saved. For example, it is possible to selectively use such that only permanent data is saved in normal power-cut, and core dump data is saved in addition to the permanent data in a case of instantaneous power failure and the like.

### 4. Fourth Embodiment

In the embodiments described above, a configuration in which the host computer 100 can directly access the address space of the volatile memory 210 has been employed. Whereas, in this fourth embodiment, every access from a host computer 100 is to be mediated by a memory controller 240, and a memory space is virtualized.

[System Configuration]

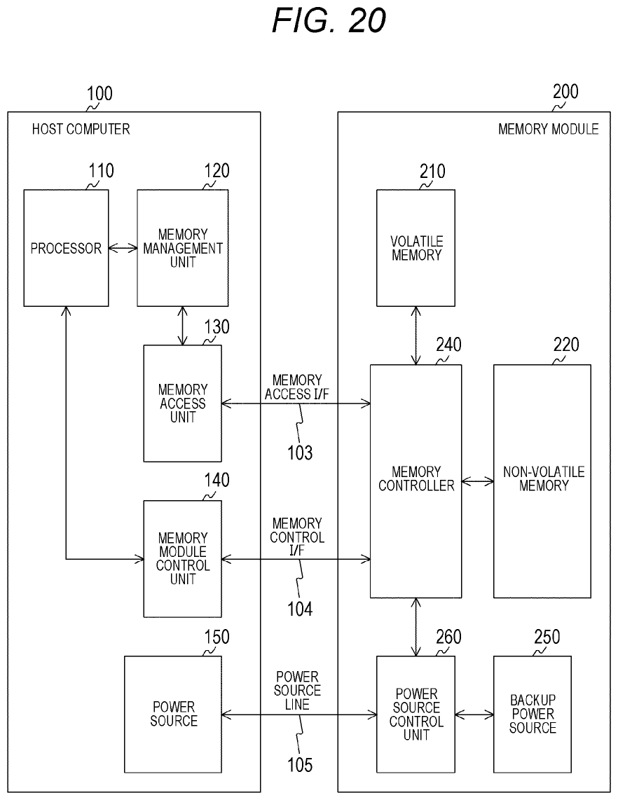

FIG. 20 is a diagram illustrating an example of an overall configuration of an information processing system according to the fourth embodiment of the present technology.

In this fourth embodiment, the multiplexer 230 in the first embodiment described above is not provided, and a connection destination of a memory access interface 103 is set to the memory controller 240. Therefore, access from the host computer 100 to a volatile memory 210 is mediated by the memory controller 240. Therefore, an address space of a memory module 200 is virtualized, and the memory module 200 can be accessed from the host computer 100 without awareness of the volatile memory 210 or a non-volatile memory 220. Furthermore, at a time of power interruption and the like, a save operation from the volatile memory 210 into the non-volatile memory 220 is performed similarly to other embodiments described above.

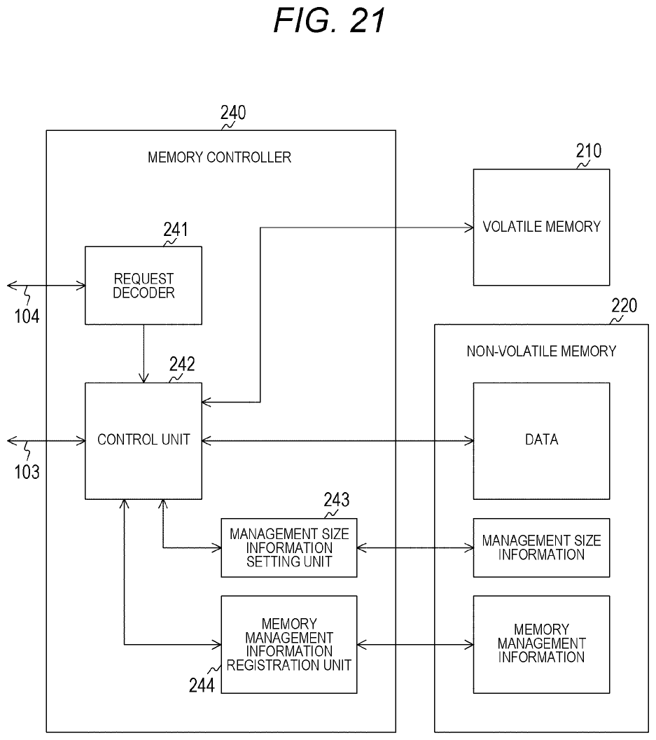

FIG. 21 is a diagram illustrating a configuration example of the memory controller 240 according to the fourth embodiment of the present technology.

The memory controller 240 in this fourth embodiment differs from that of the first embodiment described above in that a control unit 242 is connected to the memory access interface 103. Upon accepting memory access from the host computer 100, the control unit 242 allocates an access destination to the volatile memory 210 or the non-volatile memory 220 in accordance with an address. Therefore, access from the host computer 100 can be accepted without making the host computer 100 aware of distinction between the volatile memory 210 and the non-volatile memory 220. That is, an address space as the memory module 200 is virtualized.

Thus, according to the fourth embodiment of the present technology, by allocating the access destination of the memory access from the host computer 100 in the control unit 242, the address space as the memory module 200 can be virtualized.

Note that the embodiments described above are examples for embodying the present technology, and the matters in the embodiments and the matters specifying the invention in the claims individually have a corresponding relationship. Similarly, the matters specifying the invention in the claims and the matters in the embodiments of the present technology to which the same names are assigned have a corresponding relationship individually. However, the present technology is not limited to the embodiments, and can be embodied by applying various modifications to the embodiments without departing from the gist thereof.

Furthermore, the processing procedure described in the embodiments described above may be regarded as a method having a series of these procedures, and may be regarded as a program for causing a computer to execute the series of procedures, or a recording medium storing the program. As this recording medium, for example, a compact disc (CD), a MiniDisc (MD), a digital versatile disk (DVD), a memory card, a Blu-ray (registered trademark) disc, or the like can be used.

Note that the effects described in this specification are merely examples and are not limited, and additional effects may be present.

Note that the present technology can also have the following configurations. (1) A memory controller including:

a memory management information registration unit that registers, as an entry of memory management information, a physical address of a first memory that is a volatile memory and an address of a second memory that is a non-volatile memory, in association for every management unit; and

a control unit that saves data from the first memory into the second memory in accordance with the memory management information in response to a save request, and restores data from the second memory into the first memory in accordance with the memory management information in response to a restore request.

(2) The memory controller according to (1), in which

the memory management information registration unit registers, as the memory management information, a physical address of the first memory and an address of the second memory in association for every application.

(3) The memory controller according to (2), in which

the control unit saves data from a physical address of the first memory to an address of the second memory in accordance with an entry of the memory management information corresponding to an application specified in the save request, and restores data from an address of the second memory to a physical address of the first memory in accordance with an entry of the memory management information corresponding to an application specified in the restore request.

(4) The memory controller according to any one of (1) to (3), in which

the memory management information registration unit registers, as the memory management information, a physical address of the first memory, an address of the second memory, and an attribute related to a save operation in association for every application, and

the control unit saves data from a physical address of the first memory to an address of the second memory in accordance with an attribute of an entry of the memory management information corresponding to an application specified in the save request.

(5) The memory controller according to any one of (1) to (4), in which

the control unit is connected to a memory access interface between with a host computer, and accesses the first or second memory in response to a request from the host computer.

(6) The memory controller according to any one of (1) to (5), further including:

a management size setting unit that sets, as a management size, a size of the management unit corresponding to each entry in the memory management information, in which

the control unit performs a process corresponding to the save request or the restore request in accordance with the management size.

(7) The memory controller according to any one of (1) to (6), in which

the control unit generates a new entry in a case where there is no entry of the memory management information corresponding to an application specified in a registration request of the memory management information, and registers, in a case where there is a corresponding entry, a physical address specified in the registration request into the entry.

(8) The memory controller according to any one of (1) to (7), in which

the memory management information registration unit registers, as the memory management information, a virtual address and a physical address of the first memory and an address of the second memory in association for every application.

(9) The memory controller according to (8), in which

the control unit generates a new entry in a case where there is no entry of the memory management information corresponding to an application and a virtual address that are specified in a registration request of the memory management information, and registers, in a case where there is a corresponding entry, a physical address specified in the registration request into the entry.

(10) A memory module including:

a first memory that is a volatile memory;

a second memory that is a non-volatile memory;

a memory management information registration unit that registers, as an entry of memory management information, a physical address of the first memory and an address of the second memory in association for every management unit; and

a control unit that saves data from the first memory into the second memory in accordance with the memory management information in response to a save request, and restores data from the second memory into the first memory in accordance with the memory management information in response to a restore request.

### REFERENCE SIGNS LIST

100 Host computer
103 Memory access interface
104 Memory control interface
105 Power source line
110 Processor
120 Memory management unit
130 Memory access unit
140 Memory module control unit
150 Power source
200 Memory module
210 Volatile memory
220 Non-volatile memory
230 Multiplexer
240 Memory controller
241 Request decoder
242 Control unit
243 Management size information setting unit
244 Memory management information registration unit
250 Backup power source
260 Power source control unit

1. A memory controller comprising:
a memory management information registration unit that registers, as an entry of memory management information, a physical address of a first memory that is a volatile memory and an address of a second memory that is a non-volatile memory, in association for every management unit; and
a control unit that saves data from the first memory into the second memory in accordance with the memory management information in response to a save request, and restores data from the second memory into the first memory in accordance with the memory management information in response to a restore request.

2. The memory controller according to claim 1, wherein
the memory management information registration unit registers, as the memory management information, a physical address of the first memory and an address of the second memory in association for every application.

3. The memory controller according to claim 2, wherein
the control unit saves data from a physical address of the first memory to an address of the second memory in accordance with an entry of the memory management information corresponding to an application specified in the save request, and restores data from an address of the second memory to a physical address of the first memory in accordance with an entry of the memory management information corresponding to an application specified in the restore request.

4. The memory controller according to claim 1, wherein
the memory management information registration unit registers, as the memory management information, a physical address of the first memory, an address of the second memory, and an attribute related to a save operation in association for every application, and
the control unit saves data from a physical address of the first memory to an address of the second memory in accordance with an attribute of an entry of the memory management information corresponding to an application specified in the save request.

5. The memory controller according to claim 1, wherein
the control unit is connected to a memory access interface between with a host computer, and accesses the first or second memory in response to a request from the host computer.

6. The memory controller according to claim 1, further comprising:
a management size setting unit that sets, as a management size, a size of the management unit corresponding to each entry in the memory management information, wherein
the control unit performs a process corresponding to the save request or the restore request in accordance with the management size.

7. The memory controller according to claim 1, wherein
the control unit generates a new entry in a case where there is no entry of the memory management information corresponding to an application specified in a registration request of the memory management information, and registers, in a case where there is a corresponding entry, a physical address specified in the registration request into the entry.

8. The memory controller according to claim 1, wherein
the memory management information registration unit registers, as the memory management information, a virtual address and a physical address of the first memory and an address of the second memory in association for every application.

9. The memory controller according to claim 8, wherein
the control unit generates a new entry in a case where there is no entry of the memory management information corresponding to an application and a virtual address that are specified in a registration request of the memory management information, and registers, in a case where there is a corresponding entry, a physical address specified in the registration request into the entry.

10. A memory module comprising:
a first memory that is a volatile memory;
a second memory that is a non-volatile memory;
a memory management information registration unit that registers, as an entry of memory management information, a physical address of the first memory and an address of the second memory in association for every management unit; and
a control unit that saves data from the first memory into the second memory in accordance with the memory management information in response to a save request, and restores data from the second memory into the first memory in accordance with the memory management information in response to a restore request.
